(19) United States
(12) Patent Application Publication
(10) Pub. No.: US 2021/0362301 A1
(43) Pub. Date: Nov. 25, 2021

(54) TOOL JAW WIDTH ADJUSTMENT STRUCTURE

(71) Applicant: Ien U Wang, Taichung City (TW)

(72) Inventor: Ien U Wang, Taichung City (TW)

(21) Appl. No.: 16/877,890

(22) Filed: May 19, 2020

(51) Int. Cl. B25B 7/04

(52) U.S. Cl. CPC B25B 7/04

(57) ABSTRACT

A tool jaw width adjustment structure includes a first plier body and a second plier body that cross each other. The first plier body has an elongated hole. One side of the elongated hole is provided with a toothed portion. The second plier body is provided with a shaft inserting through the elongated hole. A distal end of the shaft is provided with a side plate extending beyond one side of the toothed portion. The shaft is provided with a toothed block meshing with the toothed portion. When the second plier body is opened relative to the first plier body, the shaft is driven to move from a first position to a second position in the elongated hole, so as to increase a width between jaws of the first and second plier body.

### FIELD OF THE INVENTION

The present invention relates to hand tools, and more particularly to a pair of pliers.

### BACKGROUND OF THE INVENTION

Pliers are a labor-saving tool using the principle of leverage. In order to improve the labor-saving effect, the effort arm of the pliers should be long and the resistance arm should be short. However, the short resistance arm will cause the situation that the jaws cannot be opened enough to grip the workpiece properly. On the other hand, if the jaws are designed to have a predetermined width, the effort arm (namely, the plier handles) will be longer, and the distance between the distal ends of the plier handles will be greater. As a result, it is difficult to operate the pliers with one hand. Taiwan Utility Model Publication No. M412843 discloses carp pliers. One plier body is provided with a window. The window has two wide ends and a narrow middle. Another plier body has a pivot inserting into the window. When the two plier bodies are relatively opened, the pivot will be moved in the window to increase the width of the jaws.

However, in the above-mentioned conventional structure, the pivot is formed into an elongated flat shape, and it is oriented toward a specific orientation to pass through the passage in the narrow middle of the window. Thus, it is necessary to adjust the position of the pivot before opening the pliers for the jaws to be opened wide. The operation is complicated. On the other hand, the user needs to perform the above-mentioned operation with both hands. The operation cannot be completed with one hand, leading to inconvenience in use. Accordingly, the inventor of the present invention has devoted himself based on his many years of practical experiences to solve these problems.

### SUMMARY OF THE INVENTION

The primary object of the present invention is to provide a tool jaw width adjustment structure. When the tool is opened, the shaft is moved to expand the jaws of the tool. The present invention has the effects of simple structure and convenient operation.

In order to achieve the above object, the present invention provides a tool jaw width adjustment structure, comprising:

a first plier body, having an elongated hole, the elongated hole having a width that is consistent in its length direction, one side of the elongated hole being provided with a toothed portion extending along its length direction;

a second plier body crossing the first plier body, the second plier body being provided with a shaft inserting through the elongated hole, a distal end of the shaft being provided with a side plate extending beyond one side of the toothed portion, the shaft being provided with a toothed block meshing with the toothed portion;

wherein when the second plier body is opened relative to the first plier body, the shaft is driven to move from a first position to a second position in the elongated hole, so as to increase a width between jaws of the first and second plier body.

In an embodiment, the second plier body has a through hole. One side of the through hole is provided with a retaining nut. One end of the shaft is inserted through the through hole to be locked to the retaining nut.

In an embodiment, the shaft is connected to the second plier body by riveting.

### BRIEF DESCRIPTION OF THE DRAWINGS

FIG. 1 is an exploded view of the present invention;

FIG. 2 is a partial schematic view of the present invention; and

FIG. 3 and FIG. 4 are schematic views of the present invention when in use.

### DETAILED DESCRIPTION OF THE PREFERRED EMBODIMENTS

Embodiments of the present invention will now be described, by way of example only, with reference to the accompanying drawings.

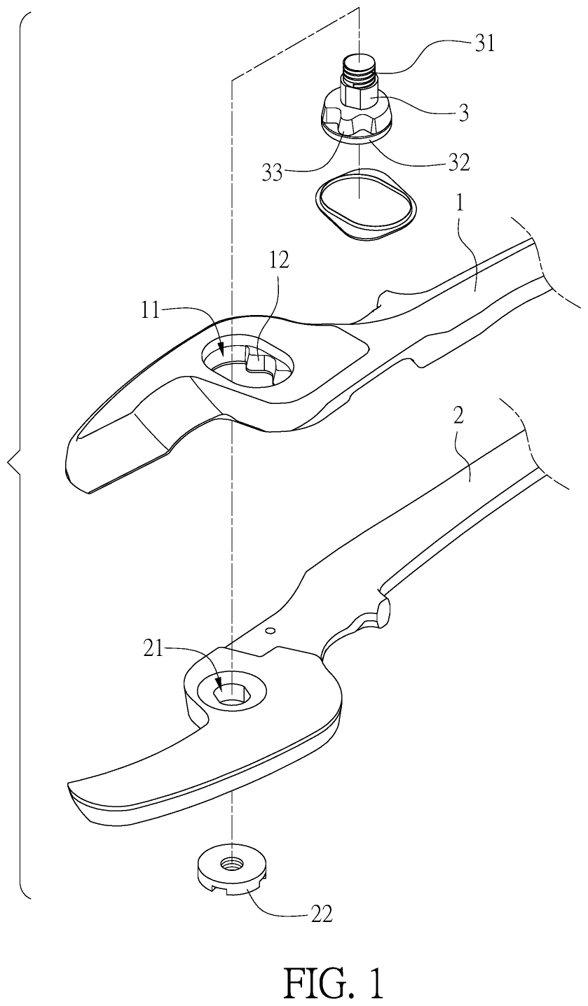

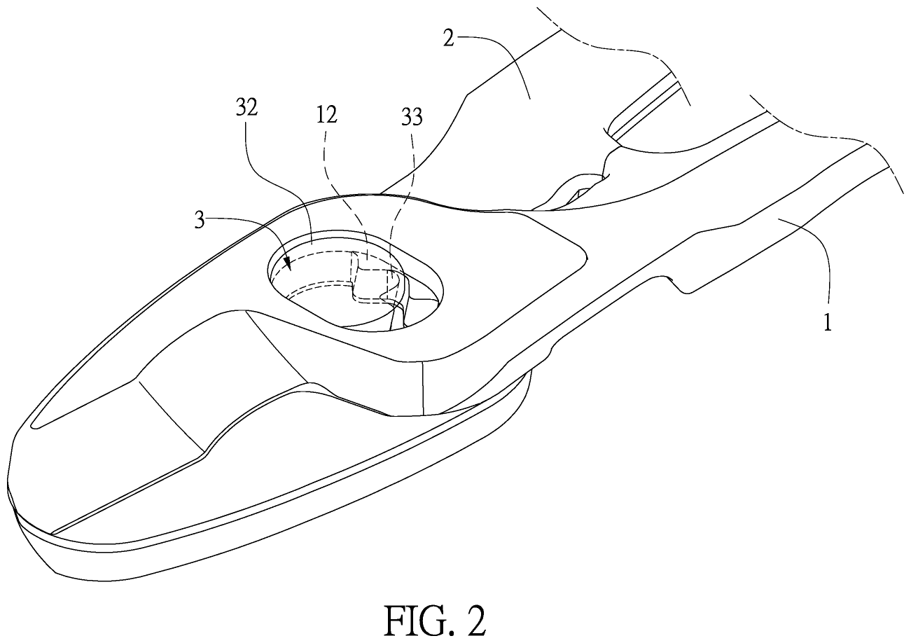

Referring to FIG. 1 and FIG. 2, a tool jaw width adjustment structure according to an embodiment of the present invention comprises a first plier body 1 and a second plier body 2 that cross each other. The first plier body 1 has an elongated hole 11. One side of the elongated hole 11 is provided with a toothed portion 12 extending along its length direction. The toothed portion 12 is integrally formed with the first plier body 1 by forging and pressing, so as to achieve the purpose of high strength.

The second plier body 2 has a through hole 21 corresponding in position to the elongated hole 11. One side of the through hole 21 is provided with a retaining nut 22. A shaft 3 is provided with a threaded section 31 at one end thereof. The threaded section 31 passes through the elongated hole 11 and the through hole 21 to be locked to the retaining nut 22, so as to be fixed to the second plier body 2. In other embodiments, the shaft 3 may be connected to the second plier body 2 by riveting.

The shaft 3 is inserted through the elongated hole 11, and is provided with a side plate 32 at its distal end. The side plate 32 extends beyond one side of the toothed portion 12, so that the first plier body 1 is positioned on the second plier body 2 because the toothed portion 12 is blocked by the side plate 32. A cover plate that shields the side plate 32 is provided on one side of the first plier body 1 to prevent debris from entering the elongated hole 11.

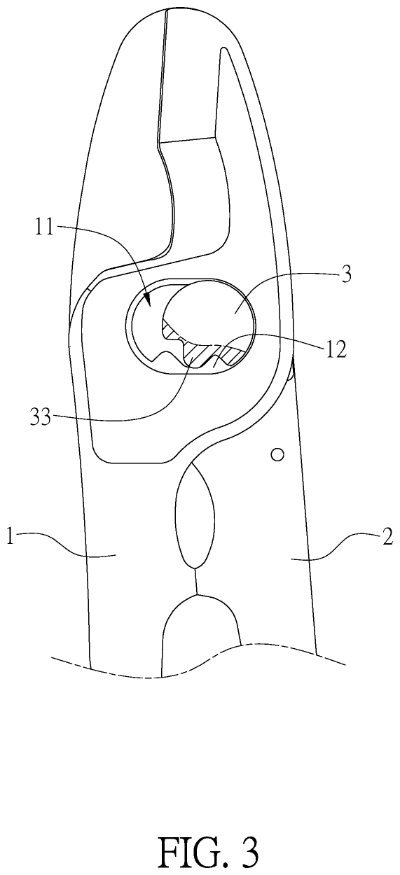

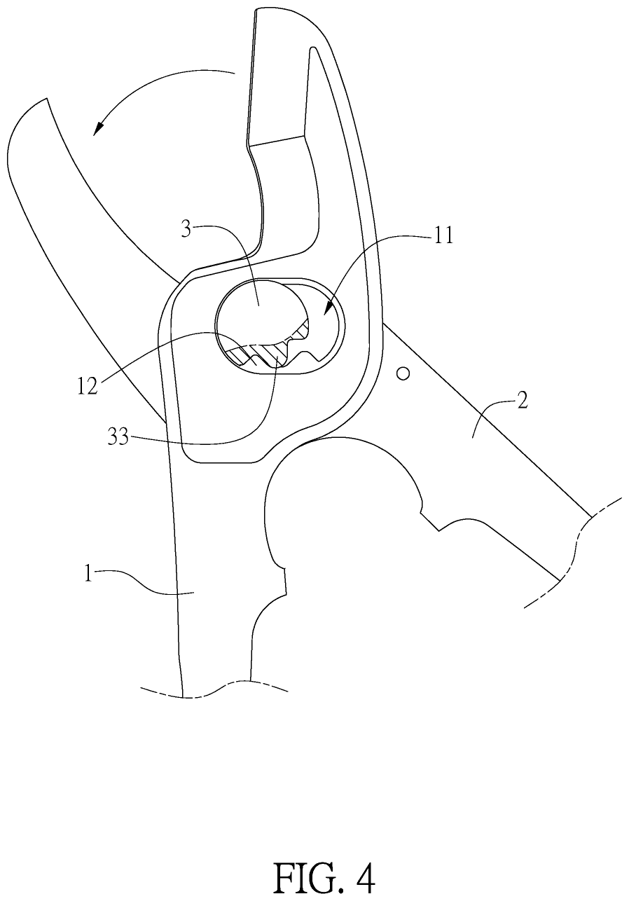

One side of the shaft 3 is provided with a toothed block 33 meshing with the toothed portion 12. The toothed block 33 and the toothed portion 12 may have straight teeth or oblique teeth to mesh with each other. When the second plier body 2 is pivotally opened relative to the first plier body 1, the shaft 3 is moved from a first position, as shown in FIG. 3, to a second position, as shown in FIG. 4, in the elongated hole 11 along with rotation of the second plier body 2 through the meshing relationship between the toothed block 33 and the toothed portion 12. When the two plier bodies are opened, the displacement of the shaft 3 in the elongated hole 11 increases the width between the jaws. This is beneficial for clamping larger workpieces.

With the above structure, when the two plier bodies of the present invention are opened, the shaft 3 will move in the elongated hole 11 synchronously with the pivoting movement of the second plier boy 2. There is no need for the user to manually adjust the position of the shaft 3. Thereby, it is convenient for the user to hold the pliers with one hand to open the two plier bodies. The width between the jaws can automatically increase, thereby achieving the effects of easy operation and convenient use.

What is claimed is:

1. A tool jaw width adjustment structure, comprising:
a first plier body, having an elongated hole, the elongated hole having a width that is consistent in a length direction, one side of the elongated hole being provided with a toothed portion extending along the length direction;
a second plier body crossing the first plier body, the second plier body being provided with a shaft inserting through the elongated hole, a distal end of the shaft being provided with a side plate extending beyond one side of the toothed portion, the shaft being provided with a toothed block meshing with the toothed portion;
wherein when the second plier body is opened relative to the first plier body, the shaft is driven to move from a first position to a second position in the elongated hole, so as to increase a width between jaws of the first and second plier body.

2. The tool jaw width adjustment structure as claimed in claim 1, wherein the toothed block and the toothed portion have straight teeth or oblique teeth to mesh with each other.

3. The tool jaw width adjustment structure as claimed in claim 1, wherein the second plier body has a through hole, one side of the through hole is provided with a retaining nut, and one end of the shaft is inserted through the through hole to be locked to the retaining nut.

4. The tool jaw width adjustment structure as claimed in claim 1, wherein the shaft is connected to the second plier body by riveting.
